(19) United States
(12) Patent Application Publication
(10) Pub. No.: US 2021/0301425 A1
(43) Pub. Date: Sep. 30, 2021

(54) IMPROVED SOFTNESS FOR POLYPROPYLENE SPUNBOND

(71) Applicant: Kimberly-Clark Worldwide, Inc., Neenah, WI (US)

(72) Inventors: Mehdi Gholipour Baradari, Roswell, GA (US); Jeffrey Krueger, Roswell, GA (US)

(21) Appl. No.: 17/264,741

(22) PCT Filed: Jul. 25, 2019
(86) PCT No.: PCT/US19/43483

§ 371 Date: Jan. 29, 2021

Related U.S. Application Data
(60) Provisional application No. 62/712,709, filed on Jul. 31, 2018.

(51) Int. Cl. D01F 6/46; D04H 3/007

(52) U.S. Cl. CPC D01F 6/46; D04H 3/007; D10B 2401/02; D10B 2321/022; D10B 2509/026

(57) ABSTRACT

The present invention is generally directed to cloth-like nonwoven webs. More specifically, the present invention is directed to a spunbond fabric made from a polymer blend that includes a high tacticity polyolefin such as polypropylene, a low tacticity polyolefin such as polypropylene and a propylene-ethylene copolymer for improving softness of a nonwoven web.

This application claims priority from U.S. provisional Patent Application Ser. No. 62/712,709 filed on 31 Jul. 2018, the entire contents of which are incorporated herein by reference.

### BACKGROUND OF THE DISCLOSURE

Many woven and nonwoven webs and fabrics are formed from thermoplastic polymers, such as polypropylene and polyethylene. For instance, spunbond webs, which are used to make diapers, disposable garments, personal care articles, and the like, are made by spinning a polymeric resin into fibers, such as filaments, and then thermally bonding the fibers together. More particularly, the polymeric resin is typically first heated to at least its softening temperature and then extruded through a spinnerette to form fibers, which can then be subsequently fed through a fiber draw unit. From the fiber draw unit, the fibers are spread onto a foraminous surface where they are formed into a web of material.

Spunbond fabrics have proven to be very useful for many diverse applications. In particular, the webs are often used to construct liquid absorbent products, such as diapers, feminine hygiene products, and wiper products. The nonwoven webs are also useful in producing disposable garments, various hospital products, such as pads, curtains, and shoe covers and recreational fabrics, such as tent covers. Although well suited for these applications, recently, attention has focused on making the nonwoven webs more cloth-like in order to avoid the plastic-like feel and look of such fabrics. Cloth, as opposed to plastic fabrics, has a more pleasing appearance and feel.

In the past, various attempts have been made to produce more cloth-like fibers from plastic materials in order to produce fibrous webs. For instance, in U.S. Pat. No. 4,254,182 to Yamaguchi, et al., polyester synthetic fibers are disclosed having an irregular uneven random surface formed by microfine recesses and projections to provide more natural feeling fibers. The microfine recesses and projections are produced by incorporating into the fibers silica in a size ranging from 10 to 150 microns and in an amount so as to produce surface projections. It is taught that the surface projections effectively increase the surface area of the fibers and contribute to greater frictional forces, which reduce the slick, waxy feel that is typically associated with plastic resins.

The prior art, however, merely teaches increasing the frictional characteristics of the polymeric fibers in order to remove the wax-like feel of plastics and thus improve cost-effectiveness. A need remains though for making nonwoven fabric made by a spunbond process to improve softness. In particular, a need exists for more cloth-like fibrous webs and laminates thereof made from a polypropylene/polymer blend of fibers that are stronger and softer than conventionally made webs while keeping such fabric cost effective.

### SUMMARY OF THE DISCLOSURE

In view of the present invention, it has been surprisingly and unexpectedly found that by applying a polymer blend which includes a high tacticity polyolephin such as polypropylene, a low tacticity polyolefin such as polypropylene and a propylene-ethylene copolymer will result in a spunbond fabric softness improvement and fabric strength in comparison with fabrics on the market today.

Additional polyolefins that may help contribute to the effectiveness of spunbond fabric softness includes polybutylene and other propylene based copolymers such as propylene-butylene. The key for successfully utilizing these polyolefins is for such combination to be miscible with the high tacticity polyolephin and to have low modulus.

In another embodiment of the present disclosure, a nonwoven web comprises fibers made from a blend of polypropylene polymer PP 3155™, Vistamaxx™ (VXM) 7050 and L-MODU S400™. The nonwoven web is made by a spunbond process wherein the nonwoven web comprises from about 75% to about 90% of PP about 4% to about 22% VXM 7050 and about 4% to about 22% of L-MODU S400™.

In an additional embodiment of the current disclosure, the nonwoven web may be made from a process for preparing a nonwoven web according to the preceding embodiments.

### DETAILED DESCRIPTION OF THE DISLOSURE

When introducing elements of the present disclosure or the preferred embodiment(s) thereof, the articles “a”, “an”, and “the” are intended to mean that there are one or more of the elements.

The terms “comprising”, “including” and “having” are intended to be inclusive and mean that there may be additional elements other than the listed elements.

The term “absorbent article” refers to devices that absorb and contain body exudates, and, more specifically, refers to devices that are placed against or in proximity to the body of the wearer to absorb and contain the various exudates discharged from the body. Absorbent articles may include pantiliners, sanitary napkins, interlabial devices, adult incontinence devices, bandages, wipes, diapers, training pants, undergarments, other feminine hygiene products, breast pads, care mats, bibs, wound dressing products, and the like.

The term “nonwoven web” is a manufactured sheet, web or batt of directionally or randomly orientated fibers, bonded by friction, and/or cohesion and/or adhesion, excluding paper and products which are woven, knitted, tufted, stitch-bonded incorporating binding yarns or filaments, or felted by wet-milling, whether or not additionally needled. Nonwovens may include hydroentangled nonwovens. The fibers may be of natural or man-made origin and may be staple or continuous filaments or be formed in situ. Commercially available fibers have diameters ranging from less than about 0.001 mm to more than about 0.2 mm and they come in several different forms: short fibers (known as staple, or chopped), continuous single fibers (filaments or monofilaments), untwisted bundles of continuous filaments (tow), and twisted bundles of continuous filaments (yarn). Nonwoven fabrics can be formed by many processes such as meltblowing, spunbonding, solvent spinning, electrospinning, and carding. The basis weight of nonwoven fabrics is usually expressed in grams per square meter (gsm).

As used herein the term “polymer” generally includes but is not limited to, homopolymers, copolymers, such as for example, block, graft, random and alternating copolymers, terpolymers, etc. and blends and modifications thereof.

As used herein the term “polypropylene (PP) 3155™” belongs to the group of polyolefins and is partially crystalline and non-polar. Its properties are similar to polyethylene, but it is slightly harder and more heat resistant. It is a white, mechanically rugged material and has a high chemical resistance.

As used herein the terms “Vistamaxx™ 7050” “Vistamaxx™ 8880, 6102 or 6202” refer to semi-crystalline copolymers of propylene and ethylene produced using ExxonMobil's (Irving, Tex.) proprietary metallocene catalyst technology.

As used herein the term “L-MODU™” or more specifically “L-MODU S400™” refers to Low Molecular weight and Low Modulus polypropylene. L-MODU™ is made by Idemitsu in Tokyo, Japan. The low melting point, low molecular weight and low modulus polypropylene, along with its range of viscosities, make L-MODU™ an ideal choice for using in non-woven fabrics particularly in the current invention.

As used herein the term “mBrace™” is a softening additive from Americhem in Cuyahoga Falls, Ohio, USA.

As used herein the term “blend” means a mixture of two or more polymers while the term “alloy” means a sub-class of blends wherein the components are immiscible but have been compaticilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

Generally speaking, the present invention is directed to a nonwoven web that contains a plurality of fibers that are formed from a polyolefin composition particularly a polypropylene composition. The polyolefin composition may contain a blend of a polypropylene polymer PP 3155 with the following additives: Vistamaxx™ (VXM) 7050, Vistamaxx™ (VXM) 8880,L-MODU S400™, and an mBrace™ material which is a slip agent additive (anti slippage) and other similar polymers such as Vistamaxx™ 6102 and Vistamaxx™ 6202. More preferably, the polyolefin composition contains a blend of PP3155™, VXM 7050™ and L-MODU S400™.

PP 3155™ has high tacticity whereas L-MODU S400™ demonstrates a low tacticity and VISTAMAXX™ (VXM) 7050 is a propylene-ethylene copolymer. It has been surprisingly and unexpectedly found that the combination of PP 3155 and Vistamaxx™ 7050 at a ratio of about 75% to about 90% of PP 3155 and a ratio of about 4% to about 22% VXM 7050 and about 4% to about 22% L-MODU S400 demonstrates superior softness and strength and smaller fiber size while maintaining a cost effective nonwoven fabric. Please see tables 2, 3 and 4. In addition, the combination of PP3155 (about 82% to about 85%) and VXM 7050 (about 7% to about 8%) and L-MODU S400 (about 7% to about 8%) have shown superior softness, strength and cost effectiveness as shown in tables 2, 3 and 4.

As indicated above, the polymer composition contains about 75% to about 90% of PP 3155™ and about 4% to about 22% VXM 7050 or about 82% to about 85% PP 3155 and VXM 7050 (about 7% to about 8%) and L-MODU S400 (about 7% to about 8%). Please see tables 1-4. Of course, the actual amount of such polymers may vary depending on the presence of any optional additives in the composition. Examples of such additives may include, for instance, fillers, pigments, antioxidants, stabilizers (e.g., melt stabilizers, light stabilizers, heat stabilizers, etc.), surfactants, flow promoters, solid solvents, plasticizers, particulates, bonding agents, tackifiers, viscosity modifiers, etc. When employed, additives typically constitute from about 0.001 weight percent to about 10 weight percent, in some embodiments from about 0.01 to about 8 weight percent, and in some embodiments, from about 0.1 weight percent to about 5 weight percent of the first polyolefin composition.

Any of a variety of known techniques may generally be employed to form the polymer composition disclosed herein. For instance, the olefin (propylene) polymers may be formed using a free radical or a coordination catalyst (e.g., Ziegler-Natta). Typically, polypropylene polymers are formed from a single-site coordination catalyst, such as a metallocene catalyst. Such a catalyst system produces ethylene polymers in which a comonomer is randomly distributed within a molecular chain and uniformly distributed across the different molecular weight fractions. Metallocene-catalyzed polyolefins are described, for instance, in U.S. Pat. No. 5,571,619 to McAlpin et al.; U.S. Pat. No. 5,322,728 to Davis et al.; U.S. Pat. No. 5,472,775 to Obijeski et al.; U.S. Pat. No. 5,272,236 to Lai et al.; and U.S. Pat. No. 6,090,325 to Wheat, et al. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (Mw/Mn) of below 4, controlled short chain branching distribution, and controlled isotacticity.

Any of a variety of propylene polymers having the characteristics noted above may generally be employed in the present invention. In one particular embodiment, for instance, the propylene polymer is an isotactic or syndiotactic homopolymer or copolymer (e.g., random or block) containing about 10 weight percent or less of co-monomers (e.g., a-olefins), and in some embodiments, about 2 weight percent or less. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. Such polymers are typically formed using a Zeigler-Natta catalyst, either alone or in combination with a small amount of an a-olefin co-monomer. Isotactic polymers, for instance, typically have a density in the range of from 0.88 to 0.94 g/cm3, and in some embodiments, from about 0.89 to 0.91 g/cm3, such as determined in accordance with ASTM 1505-10. Commercially available rigid propylene homopolymers may include, for instance, Metocene™ MF650Y and MF650X, which are available from Basel Polyolefins, as well as PP 3155, which is available from Exxon Mobil. Other examples of suitable propylene polymers may be described in U.S. Pat. No. 6,500,563 to Datta, et al; U.S. Pat. No. 5,539,056 to Yana, et al.; and U.S. Pat. No. 5,596,052 to Resconi, et al.

Rigid propylene polymers generally constitute from about 75 weight percent to about 85 weight percent.

Additionally, and generally speaking, the VXM™ 7050 copolymer has a density lower than that of certain polyolefins, but approaching and/or overlapping that of other elastomers. For example, the density of the copolymer may be about 0.91 grams per cubic centimeter (g/cm3) or less, in some embodiments from about 0.85 to about 0.89 g/cm3, and in some embodiments, from about 0.85 g/cm3 to about 0.88 g/cm3. Such propylene copolymers are commercially available under the designations VISTAMAXX™ from ExxonMobil Chemical Co. and VERSIFY™ available from Dow Chemical Co.

### Optional Additives

If desired, various other additives may also be employed. Examples of such additives may include, for instance, elastomers (e.g., styrenic elastomers, olefinic elastomers, etc.), fillers, pigments, antioxidants, stabilizers (e.g., melt stabilizers, light stabilizers, heat stabilizers, etc.), surfactants, flow promoters, solid solvents, plasticizers, particulates, bonding agents, tackifiers, viscosity modifiers, etc. When employed, such additives typically constitute from about 0.001 weight percent to about 15 weight percent.

### Nonwoven Webs

The fibers of the nonwoven web may generally have any of a variety of different configuration as is known in the art. For example, monocomponent and/or multicomponent fibers may be employed. Monocomponent fibers, for instance, are typically formed by extruding a polymer composition from a single extruder. Multicomponent fibers, on the other hand, are generally formed from two or more polymer compositions (e.g., bicomponent fibers) extruded from separate extruders. The polymer compositions may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al. and U.S. Pat. No. 5,336,552 to Strac et al., U.S. Pat. No. 5,108,820 to Kaneko, et al., U.S. Pat. No. 4,795,668 to Krueae, et al., U.S. Pat. No. 5,382,400 to Pike, et al., U.S. Pat. No. 5,336,552 to Strack, et al., and U.S. Pat. No. 6,200,669 to Marmon, et al. Multicomponent fibers having various irregular shapes may also be formed, such as described in U.S. Pat. No. 5,277,976 to Hogle et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al.

The fibers may constitute the entire fibrous component of the nonwoven web or blended with other types of fibers. When blended with other types of fibers, it is normally desired that the fibers of the present invention constitute from about 20 wt percent to about 99 weight percent of a web.

A spunbond process techniques may be employed to form the nonwoven web. For example, in one embodiment, the nonwoven webs may be formed by a spunbond process in which the polyolefin (PP) composition is fed to an extruder and extruded through a conduit to a spinneret. Spinnerets for extruding fibers are well known to those of skill in the art. For example, the spinneret may include a housing containing a spin pack having a plurality of plates stacked one on top of each other and having a pattern of openings arranged to create flow paths for the polymer composition. The spinneret may also have openings arranged in one or more rows that form a downwardly extruding curtain of fibers when the polymer composition is extruded there through. The process may also employ a quench blower positioned adjacent the curtain of fibers extending from the spinneret. Air from the quench air blower may quench the fibers as they are formed. A fiber draw unit or aspirator may also be positioned below the spinneret to receive the quenched fibers. Fiber draw units or aspirators for use in melt spinning polymers are well-known in the art. The fiber draw unit may include an elongate vertical passage through which the fibers are drawn by aspirating air entering from the sides of the passage and flowing downwardly through the passage. A heater or blower may supply aspirating air to the fiber draw unit, which draws the fibers and ambient air through the fiber draw unit.

Generally speaking, the resulting fibers of the nonwoven web may have an average size (e.g., diameter) of about 19 microns to about 17 microns, wherein the most preferred average size of each fiber is from about 17.0 to about 17.65 microns. Please see table 3. In certain embodiments, the fibers may be in the form of substantially continuous filaments (e.g., spunbond filaments), which may have a length much greater than their diameter, such as a length to diameter ratio (“aspect ratio”) of about 15,000 to 1 or more, and in some embodiments, about 50,000 to 1 or more.

The fibers may be formed into a coherent web structure by randomly depositing the fibers onto a forming surface (optionally with the aid of a vacuum) and then bonding the resulting web using any known technique, such as with an adhesive or autogenously (e.g., fusion and/or self-adhesion of the fibers without an applied external adhesive). Autogenous bonding, for instance, may be achieved through contact of the fibers while they are semi-molten or tacky, or simply by blending a tackifying resin and/or solvent with polymer composition used to form the fibers. Suitable autogenous bonding techniques may include ultrasonic bonding, thermal bonding, through-air bonding, and so forth. Typically, the resulting basis weight of each web is about 30 grams per square meter or less, in some embodiments from about 1 to about 20 grams per square meter, and in some embodiments, from about 2 to about 10 grams per square meter.

If desired, the nonwoven web may also be subjected to one or more post-treatment steps before being combined into the composite of the present invention as is known in the art. For example, the nonwoven web may be stretched or necked in the machine and/or cross-machine directions. Suitable stretching techniques may include necking, tentering, groove roll stretching, etc. Examples of suitable stretching techniques are described in U.S. Pat. Nos. 5,336,545, 5,226,992, 4,981,747 and 4,965,122 to Morman, as well as U.S. Patent Application Publication No. 2004/0121687 to Morman, et al. Alternatively, the nonwoven web may remain relatively inextensible in at least one direction prior to forming the composite. The nonwoven web may also be subjected to other known processing steps, such as aperturing, heat treatments, etc.

### Nonwoven Composite

Once formed, the nonwoven web may then be laminated together to form a composite using any conventional technique, such as with an adhesive or autogenously. In one embodiment, for example, the nonwoven webs may be thermally bonded by passing the webs through a nip formed between a pair of rolls, one or both of which are heated to melt-fuse the fibers. One or both of the rolls may also contain intermittently raised bond points to provide an intermittent bonding pattern. The pattern of the raised points is generally selected so that the nonwoven laminate has a total bond area of less than about 50 percent (as determined by conventional optical microscopic methods), and in some embodiments, less than about 30 percent. Likewise, the bond density is also typically greater than about 100 bonds per square inch, and in some embodiments, from about 250 to about 500 pin bonds per square inch. Such a combination of total bond area and bond density may be achieved by bonding the web with a pin bond pattern having more than about 100 pin bonds per square inch that provides a total bond surface area less than about 30 percent when fully contacting a smooth anvil roll. In some embodiments, the bond pattern may have a pin bond density from about 250 to about 350 pin bonds per square inch and a total bond surface area from about 10 percent to about 25 percent when contacting a smooth anvil roll. Exemplary bond patterns include, for instance, those described in U.S. Pat. No. 3,855,046 to Hansen et al., U.S. Pat. No. 5,620,779 to Levy et al. U.S. Pat. No. 5,962,112 to Haynes et al., U.S. Pat. No. 6,093,665 to Savovitz et al., U.S. Design Pat. No. 428,267 to Romano et al. and U.S. Design Pat. No. 390,708 to Brown.

Of course, it should also be understood that the nonwoven composite may contain additional layers (e.g., nonwoven webs, films, strands, etc.) if so desired. For example, the composite may contain two (2) or more layers, and in some embodiments, from two (2) to ten (10) layers (e.g., 3 or 5 layers). In one embodiment, for instance, the nonwoven composite may contain an inner nonwoven layer (e.g., spunbond) positioned between two outer nonwoven layers (e.g., spunbond). For example, the inner nonwoven layer may be formed from the first polyolefin composition and one or both of the outer nonwoven layers may be formed from the second polyolefin composition. In another embodiment, the nonwoven composite may contain five (5) nonwoven layers, which includes a central nonwoven layer, two intermediate nonwoven layers overlying the central layer, and two outer nonwoven layers overlying the intermediate layers.

Various techniques for forming laminates of this nature are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeger; U.S. Pat. No. 5,169,706 to Collier, et al.; and U.S. Pat. No. 4,766,029 to Brock et al. Of course, the laminate may have other configurations and possess any desired number of layers, such as a spunbond/meltblown/meltblown/spunbond (“SMMS”) laminate, spunbond/meltblown (“SM”) laminate, etc. In such embodiments, the nonwoven composite of the present invention may desirably form on or more of the spunbond layers. In yet another embodiment, the nonwoven composite may be employed in a multi-layered laminate structure in which one or more additional film layers are employed. Any known technique may be used to form a film, including blowing, casting, flat die extruding, etc. The film may be a mono- or multi-layered film. Any of a variety of polymers may generally be used to form the film layer, such as polyolefins (e.g., polyethylene, polypropylene, polybutylene, etc.); polytetrafluoroethylene; polyesters (e.g., polyethylene terephthalate, polylactic acid, etc.); polyamides (e.g., nylon); polyvinyl chloride; polyvinylidene chloride; polystyrene; and so forth. In one embodiment, for instance, the film may be formed from a polyolefin polymer, such as linear, low-density polyethylene (LLDPE) or polypropylene. Examples of predominately linear polyolefin polymers include, without limitation, polymers produced from the following monomers: ethylene, propylene, 1-butene, 4-methyl-pentene, 1-hexene, 1-octene and higher olefins as well as copolymers and terpolymers of the foregoing. In addition, copolymers of ethylene and other olefins including butene, 4-methyl-pentene, hexene, heptene, octene, decene, etc., are also examples of predominately linear polyolefin polymers.

Various additional potential processing and/or finishing steps known in the art, such as slitting, stretching, etc., may be performed without departing from the spirit and scope of the invention. For instance, the composite may optionally be mechanically stretched in the cross-machine and/or machine directions to enhance extensibility. For example, the composite may be coursed through two or more rolls that have grooves in the CD and/or MD directions that incrementally stretch the composite in the CD and/or MD direction. Such grooved satellite/anvil roll arrangements are described in U.S. Patent Application Publication Nos. 2004/0110442 to Rhim, et al. and 2006/0151914 to Gerndt, et al. The grooved rolls may be constructed of steel or other hard material (such as a hard rubber). Besides grooved rolls, other techniques may also be used to mechanically stretch the composite in one or more directions. For example, the composite may be passed through a tenter frame that stretches the composite. Such tenter frames are well known in the art and described, for instance, in U.S. Patent Application Publication No. 2004/0121687 to Morman, et al. The composite may also be necked, such as described above.

In addition to possessing good mechanical properties, the nonwoven composite of the present invention is also soft, drapable, and tactile. One parameter that is indicative of the softness of the composite is the peak load (“cup crush load”) as determined according to the “cup crust” test, which is described in more detail below. More particularly, the cup crush load of the composite may, for instance, be about 200 gf or less, in some embodiments about 150 gf or less and in some embodiments, from about 5 to about 100 gf. Another parameter that is indicative of the good tactile properties of the composite is the static coefficient of friction in the machine or cross-machine direction. More particularly, the MD and/or CD coefficient of friction may be about 0.885 or less, in some embodiments about 0.850 or less, and in some embodiments, from about 0.500 to about 0.800.

If desired, the nonwoven composite of the present invention may be applied with various treatments to impart desirable characteristics. For example, the composite may be treated with liquid-repellency additives, antistatic agents, surfactants, colorants, antifogging agents, fluorochemical blood or alcohol repellents, lubricants, and/or antimicrobial agents. In addition, the composite may be subjected to an electret treatment that imparts an electrostatic charge to improve filtration efficiency. The charge may include layers of positive or negative charges trapped at or near the surface of the polymer, or charge clouds stored in the bulk of the polymer. The charge may also include polarization charges that are frozen in alignment of the dipoles of the molecules. Techniques for subjecting a fabric to an electret treatment are well known by those skilled in the art. Examples of such techniques include, but are not limited to, thermal, liquid-contact, electron beam and corona discharge techniques. In one particular embodiment, the electret treatment is a corona discharge technique, which involves subjecting the laminate to a pair of electrical fields that have opposite polarities. Other methods for forming an electret material are described in U.S. Pat. No. 4,215,682 to Kubik, et al.; U.S. Pat. No. 4,375,718 to Wadsworth; U.S. Pat. No. 4,592,815 to Nakao; U.S. Pat. No. 4,874,659 to Ando; U.S. Pat. No. 5,401,446 to Tsai, et al.; U.S. Pat. No. 5,883,026 to Reader, et al; U.S. Pat. No. 5,908,598 to Rousseau, et al.; U.S. Pat. No. 6,365,088 to Knight, et al.

### Absorbent Articles

The nonwoven composite of the present invention may be used in a wide variety of applications. For example, the nonwoven laminate or composite may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such absorbent articles are well known to those skilled in the art. Typically, absorbent articles include a substantially liquid-impermeable layer (e.g., backsheet), a liquid-permeable layer (e.g., topsheet, surge layer, etc.), and an absorbent core.

In certain embodiments, for example, the nonwoven composite of the present invention may be used to form the topsheet and/or backsheet of the absorbent article. When used to form the backsheet, the nonwoven composite may also be laminated to a film, such as described above. The film is typically liquid-impermeable and either vapor-permeable or vapor-impermeable. Films that are liquid-impermeable and vapor-permeable are often referred to as “breathable” and they typically have a water vapor transmission rate (“WVTR”) of about 100 grams per square meter per 24 hours (g/m2/24 hours) or more, in some embodiments from about 500 to about 20,000 g/m2/24 hours, and in some embodiments, from about 1,000 to about 15,000 g/m2/24 hours. The breathable film may also be a microporous or monolithic film. Microporous films are typically formed by incorporating a filler (e.g., calcium carbonate) into the polymer matrix, and thereafter stretching the film to create the pores. Examples of such films are described, for instance, in U.S. Pat. No. 5,843,057 to McCormack; U.S. Pat. No. 5,855,999 to McCormack; U.S. Pat. No. 5,932,497 to Morman, et al.; U.S. Pat. No. 5,997,981 to McCormack, et al.; U.S. Pat. No. 6,002,064 to Kobylivker, et al.; U.S. Pat. No. 6,015,764 to McCormack, et al.; U.S. Pat. No. 6,037,281 to Mathis, et al.; U.S. Pat. No. 6,111,163 to McCormack, et al.; and U.S. Pat. No. 6,461,457 to Taylor, et al.

Regardless of how it is employed, the unique properties of the propylene-based composition can allow it to impart a soft and cloth-like feel to an outwardly facing surface, which was conventionally only partially achievable with polyethylene materials (e.g., LLDPE breathable film) and generally not possible with polypropylene materials. Furthermore, contrary to polyethylene materials, the propylene-based nonwoven web can exhibit an improved degree of abrasion resistance and mechanical strength, making it even better served to define the outwardly facing surface of an absorbent article. When used in a backsheet, for example, the nonwoven web may define a “garment-facing surface”, which generally refers to an outwardly facing surface of an absorbent article that is intended to be disposed away from the body of a wearer during ordinary use. The surface is typically placed adjacent to the wearer's undergarments when the article is worn. Likewise, when used in a topsheet, the nonwoven web may define a “body-facing surface”, which generally refers to an outwardly facing surface of an absorbent article that is intended to be disposed toward or placed adjacent to the body of a wearer during ordinary use.

The present invention may be better understood with reference to the following examples.

### Test Methods

As set forth in table 1, 1.6 denier per fiber (dpf), also known as the fiber size diameter, and a 15 grams per square meter (gsm) weaving wire bond pattern was used in control number 1 and sample codes 2-9. Fiber size was measured with any known microscope in the prior art. The control and samples contained a certain percent of polypropylene (PP) 3155™ grade with additional additives at various percents that comprise of VXM™ 7050, L-MODU™ S400, VXM™ 8880 and/or an mBrace™ material that is an anti-slip additive. Please see table 1.

Table 2 shows that sample codes 4, 5 and 6 generated a surprising and unexpected softness package versus fiber size.

Table 3 demonstrates strength and average fiber size (microns) of each code specifically comparing the control code 1 with sample codes 2-9. The strength of each code was measured with a 2 inch wide strip tensile test peak load method. As shown in table 3, sample codes 4, 5 and 6 show surprising and unexpected strength versus average fiber size.

Furthermore, table 4 depicts costs ($/lb) for each code. Sample codes 1-9 correspond to codes 1-9 in FIG. 3. Additionally, sample codes 4, 5 and 6 demonstrate similar cost codes to the control and codes 2 and 3. Sample codes 4, 5 and 6 have comparable average fiber size (microns) to control 1 and codes 2 and 3.

Overall, sample codes 4, 5 and 6 demonstrate an overall finding of superior and unexpected results of cost effectiveness, strength, fiber size and softness package weight compared with the other related samples as shown in Tables 1-4.

TABLE 1

| | PP ™ | VXM ™ | L-MODU ™ | VXM ™ | mBrace ™ |
|---|---|---|---|---|---|
| Code | 3155 (%) | 7050 (%) | S400 (%) | 8880 (%) | 48137 (%) |
| 1. Control | 88.5 | 10 | 0 | 0 | 1.5 |
| 2. | 83.5 | 15 | 0 | 0 | 1.5 |
| 3. | 78.5 | 20 | 0 | 0 | 1.5 |
| 4. | 88.5 | 5 | 5 | 0 | 1.5 |
| 5. | 83.5 | 7.5 | 7.5 | 0 | 1.5 |
| 6. | 78.5 | 10 | 10 | 0 | 1.5 |
| 7. | 93.5 | 0 | 0 | 5 | 1.5 |
| 8. | 88.5 | 0 | 0 | 10 | 1.5 |
| 9. | 88.5 | 0 | 5 | 5 | 1.5 |

TABLE 3

| | | VXM ™ | | | | | Avg. Fiber |
|---|---|---|---|---|---|---|---|
| | PP 3155 ™ | 7050 | L-MODU ™ | VXM ™ | mBrace ™ | | Size |
| Code | (%) | (%) | S400 (%) | 8880 (%) | 48137 (%) | Strength | (micron) |
| 1 | 88.5 | 10 | 0 | 0 | 1.5 | 4199 | 17.40 |
| 2 | 83.5 | 15 | 0 | 0 | 1.5 | 4603 | 17.08 |
| 3 | 78.5 | 20 | 0 | 0 | 1.5 | 3373 | 17.50 |
| 4 | 88.5 | 5 | 5 | 0 | 1.5 | 4138 | 17.42 |
| 5 | 83.5 | 7.5 | 7.5 | 0 | 1.5 | 4245 | 17.62 |
| 6 | 78.5 | 10 | 10 | 0 | 1.5 | 3445 | 18.80 |
| 7 | 93.5 | 0 | 0 | 5 | 1.5 | 4636 | 17.90 |
| 8 | 88.5 | 0 | 0 | 10 | 1.5 | 4366 | 19.40 |
| 9 | 88.5 | 0 | 5 | 5 | 1.5 | 4225 | 19.60 |

### Tensile Properties (Peak Load)

The strip tensile strength values were determined in substantial accordance with ASTM D 1117-01 Breaking Load and Elongation of Fabrics and ASTM D 5035-95, Breaking Force and Elongation of Textile Fabrics (Strip Method). The peak load was measured as a 2-inch wide strip tensile test method.

### Kawabata Evaluation System (KES Surface Test)

The softness of a sample disclosed herein is measured according to the KES surface test according to WSP Standard Test No. 402.0 (09), which evaluates softness by measuring the peak load.

KES is well-known in the art and is used to measure the mechanical properties of fabrics. KES is composed of four different machines on which a total of six tests may be performed:
Tensile & shear tester—tensile, shear
Pure bending tester—pure bending
Compression tester—compression
Surface tester—surface friction and roughness

The evaluation may include measurement of the transient heat transfer properties associated with the sensation of coolness generated when fabrics contact the skin during wear. KES not only predicts human response but understands the perception of softness.

A first embodiment: A nonwoven web comprises fibers made from a blend of polypropylene polymer PP 3155™, Vistamaxx™ (VXM) 7050 and L-MODU S400™. A spunbond process is used to make the nonwoven web wherein the nonwoven web comprises from about 75% to about 90% of PP about 4% to about 22% VXM 7050™ and about 4% to about 22% of L-MODU S400™.

In another embodiment according to the preceding embodiment, the nonwoven web comprises from about 78.5% to about 85% of PP 3155™ and from about 15% to about 20% VXM 7050™ and about 15% to about 20% of L-MODU S400™.

In still another embodiment according to the preceding embodiments, a nonwoven web comprising fibers made from a blend of polypropylene polymer PP 3155, Vistamaxx™ (VXM) 7050 and L-MODU S400™ by a spunbond process wherein the nonwoven web comprises from about 88.5% of PP 3155 and about 5% VXM 7050™ and about 5% of L-MODU S400™.

In yet another embodiment according to the preceding embodiments, the nonwoven web comprises about 83.5% of PP 3155 and about 7.5% VXM 7050 and about 7.5% of L-MODU S400.

In a further embodiment according to the preceding embodiments, the nonwoven web comprises about 78.5% of PP 3155 and about 10% VXM 7050 and about 10% of L-MODU S400.

In an additional embodiment according to the preceding embodiments, the average size of each of the nonwoven web fibers are from about 17 microns to about 19 microns wherein the most preferred average size of each fiber is from about 17.0 to about 17.65 microns.

In a further embodiment according to the preceding embodiments, the nonwoven web may be laminated together to form a composite.

In an additional embodiment according to the preceding embodiments, the composite contains two or more additional nonwoven web layers.

In another additional embodiment according to the preceding embodiments, the nonwoven web is incorporated into an absorbent article.

In yet another embodiment according to the preceding embodiments, the absorbent article may be pantiliners, sanitary napkins, interlabial devices, adult incontinence devices, bandages, wipes, diapers, training pants, undergarments, other feminine hygiene products, breast pads, care mats, bibs, wound dressing products, and the like.

In an additional embodiment of the current disclosure is for a process for producing a nonwoven web according to the preceding embodiments.

1. A nonwoven web comprising fibers made from a blend of polypropylene polymer PP 3155™, Vistamaxx™ (VXM) 7050 and L-MODU S400™ by a spunbond process wherein the nonwoven web comprises from about 75% to about 90% of PP 3155™, about 4% to about 22% VXM 7050™ and from about 4% to about 22% of L-MODU S400™.

2. The nonwoven web according to claim 1, wherein the nonwoven web comprises from about 78.5% to about 85% of PP 3155™ and from about 15% to about 20% VXM 7050™ and about 15% to about 20% of L-MODU S400™.

3. The nonwoven web according to claim 1, wherein the nonwoven web comprises about 88.5% of PP 3155™ and about 5% VXM 7050™ and about 5% of L-MODU S400™.

4. The nonwoven web according to claim 1, wherein the nonwoven web comprises about 83.5% of PP 3155 and about 7.5% VXM 7050 and about 7.5% of L-MODU S400.

5. The nonwoven web according to claim 1, wherein the nonwoven web comprises about 78.5% of PP 3155 and about 10% VXM 7050 and about 10% of L-MODU S400.

6. The nonwoven web according to claim 1, wherein the average size of each of the nonwoven web fibers are from about 17 microns to about 19 microns.

7. The nonwoven web according to claim 1, wherein the nonwoven web may be laminated together to form a composite.

8. The nonwoven web according to claim 1, wherein composite contains two or more additional nonwoven web layers.

9. The nonwoven web according to claim 1, wherein the nonwoven web is incorporated into an absorbent article.

10. The nonwoven web according to claim 9, wherein the absorbent article may be pantiliners, sanitary napkins, interlabial devices, adult incontinence devices, bandages, wipes, diapers, training pants, undergarments, other feminine hygiene products, breast pads, care mats, bibs, wound dressing products, and the like.

11. (canceled)
